(19) United States
(12) Patent Application Publication
(10) Pub. No.: US 2011/0126991 A1
(43) Pub. Date: Jun. 2, 2011

(54) PROTECTIVE SCREEN SYSTEMS FOR USE ON A PLURALITY OF VEHICLES

(76) Inventor: Eddie Murphy, Powder Springs, GA (US)

(21) Appl. No.: 12/834,454

(22) Filed: Jul. 12, 2010

Related U.S. Application Data
(60) Provisional application No. 61/266,145, filed on Dec. 2, 2009.

(51) Int. Cl. E06B 9/52

(52) U.S. Cl. 160/91; 160/90

(57) ABSTRACT

A protective screen system of the present invention is disclosed herein which may be used in a variety of types and models of vehicles to keep children and pets safe during an accident, in hot weather provide a ventilation means, and to prevent bugs and debris from entering a vehicle. The protective screen system may be installed into the frame of a vehicle window and may be available in an adjustable or a non-adjustable version. The protective screen system may be manufactured using a durable material. The protective screen system may be customized to be installed into substantially any vehicle window.

### CROSS-REFERENCE TO RELATED APPLICATION

The present application is related to and claims priority from prior provisional application Ser. No. 61/266,145, filed Dec. 2, 2009 which application is incorporated herein by reference.

### BACKGROUND OF THE INVENTION

1. Field of the Invention

The present invention relates generally to the field of screens and more specifically relates to protective screens for vehicles.

2. Description of the Related Art

Vehicles are a common mode of transportation in our modern day society. Windows are provided on such vehicles to provide ventilation means for the passengers therein. When windows of a vehicle are rolled down, it is common for bugs or other debris to fly inside the vehicle. Another problem occurs when truck drivers pull off the road to rest and may want to leave the windows down for ventilation, but insects may enter causing a restless sleep.

Many pet owners transport their animals and children in their vehicle between locations. Since often the animal is unrestrained, it is a danger that the animal may jump out of an open window or be ejected in the event of an accident. In a similar manner, parents may also worry that their child may be ejected through an open vehicle window in the event of an accident. Additionally, children have a tendency to throw or drop objects out of car windows when the driver is distracted, a need exists to prevent these events from occurring. Additionally, when the vehicle is parked during summer months extra ventilation for children and/or pets may be desirable to prevent heat exhaustion and dehydration. A more suitable solution is needed.

Various attempts have been made to solve the above-mentioned problems such as those found in U.S. Pat. Nos. 4,285,383, 6,367,536, 5,524,694, 5,290,086, 5,443,110, 2,710,058, and 4,653,562. This prior art is representative of screens. None of the above inventions and patents, taken either singly or in combination, is seen to describe the invention as claimed.

Ideally, a protective screen should operate safely and be manufactured at a modest expense. Thus, a need exists for a reliable screen system to keep children and pets safe during transport, in an accident, in hot weather, while preventing bugs, debris, and other particles from entering a vehicle thereby avoiding the above-mentioned problems.

### BRIEF SUMMARY OF THE INVENTION

In view of the foregoing disadvantages inherent in the known screen art, the present invention provides a novel protective screen system. The general purpose of the present invention, which will be described subsequently in greater detail, is to provide a protective screen for vehicle windows.

A protective screen system is described herein for use with a vehicle comprising: at least one protective screen; and at least one lockable screen frame unit having a periphery; wherein the protective screen and the lockable screen frame unit are removably couplable to a vehicle window such as those found in trucks, cars, SUVs, buses, recreational vehicles and other such modes of transport.

An adjustable version of protective screen system is also provided herein which may comprise a first protective screen with a first outer perimeter and a second protective screen with a second outer perimeter wherein the first and second protective screens are movably adjustable in relation to each other via a sliding motion and in other embodiments may be non-adjustable.

Further, a method of using the protective screen system is disclosed herein for use with a vehicle comprising the steps of installing the protective screen system with a first protective screen and a second protective screen into a groove-space of a vehicle window frame and adjusting first and second protective screens in relation to each other via a sliding motion to create a user preferred open space, the open space providing adequate ventilation. The present invention may be manufactured and sold as a kit.

The present invention holds significant improvements and serves as a protective screen system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Protective Screen Systems, constructed and operative according to the teachings of the present invention.

FIG. 1 is a perspective view illustrating a protective screen system installed in a driver's side vehicle window of a tractor-trailer truck according to an embodiment of the present invention.

FIG. 2 is a perspective view which illustrates the protective screen system installed in windows of a vehicle or sedan according to an embodiment of the present invention.

FIG. 3 is a perspective view illustrating a non-adjustable version of the protective screen system in-use in a vehicle according to an embodiment of the present invention.

FIG. 4A is a perspective view illustrating a first variation of the protective screen system that is non-adjustable according to an embodiment of the present invention of FIG. 1.

FIG. 4B is a perspective view illustrating a second variation of the protective screen having adjustable first and second protective screens according to an embodiment of the present invention of FIG. 1.

FIG. 5A is a perspective view illustrating brackets as used on the non-adjustable version of the protective screen according to an embodiment of the present invention of FIG. 3.

FIG. 5B illustrates a perspective view including brackets as used on the first and second protective screens of the adjustable version of the protective screen system according to an embodiment of the present invention.

FIG. 6 is a flowchart illustrating a method of use according to an embodiment of the present invention of FIGS. 1-5B.

The various embodiments of the present invention will hereinafter be described in conjunction with the appended drawings, wherein like designations denote like elements.

### DETAILED DESCRIPTION

As discussed above, embodiments of the present invention relate to a protective screen system 100 and more particularly to a protective screen system 100 as used to improve the security and safety of motorists and/or passengers 210 inside vehicle 140 and to prevent unwanted bugs, debris, and particles from entering vehicle 140.

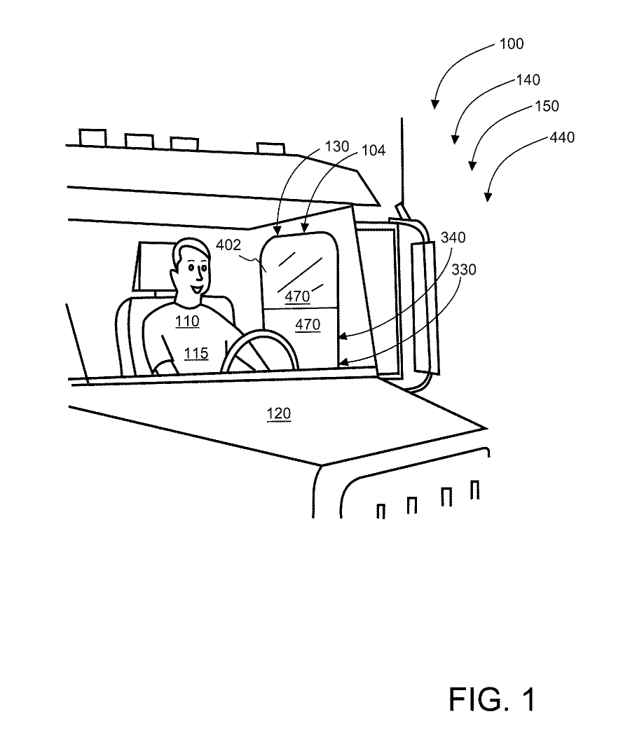

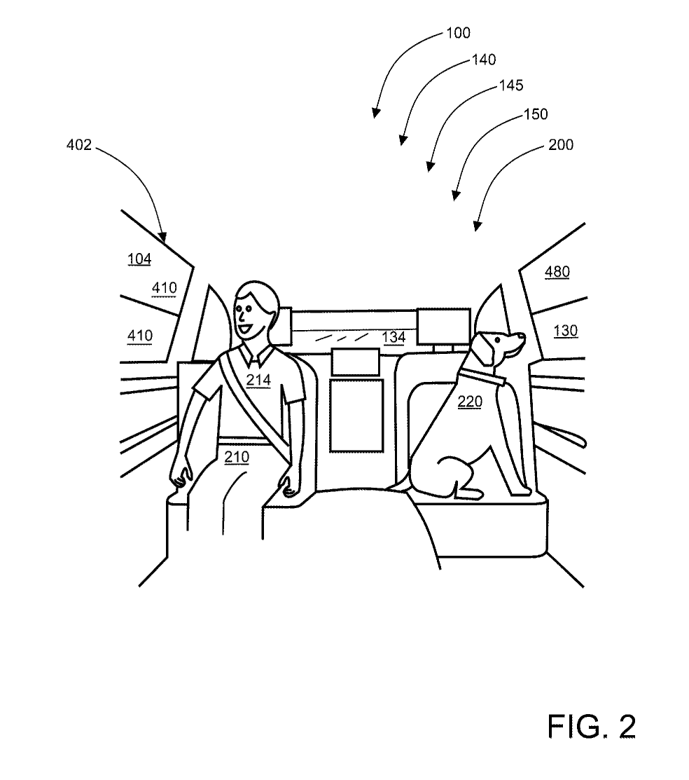

Referring now to FIG. 1, illustrating protective screen system 100 in an ‘in-use’ condition 150 installed in a driver's side vehicle window 130 of truck 120. Truck 120 in this particular figure comprises a tractor-trailer version; however it should be appreciated that the present invention may be used with trucks 120 of various sizes and models. Protective screen system 100 may comprise at least one protective screen 410 and at least one screen frame locking unit 430. Protective screen system 100 is preferably installable in at least one vehicle window 104, as shown. Vehicle window 104 on vehicle 140 includes side-window 130 and rear windows 134 (as shown in FIG. 2) and may also include other vent windows such as those found in sleepers.

Protective screen 410 and screen frame locking unit 430 may be removably couplable to vehicle window 104 via groove-space 310. When in an in-use condition 150, protective screen 410 serves to prevent debris, bugs or other unwanted objects or particles from entering vehicle 140. Additionally, protective screen 410 permits ventilation when in an in-use condition 150. For example, when a truck-driver pulls off the road for an extended period to rest, the truck-driver may prefer to have window 104 open for ventilation, yet be deterred because bugs or other unwanted objects or particles may enter vehicle 140 disrupting his rest.

Upon reading this specification, it should be appreciated that, under appropriate circumstances, considering such issues as user preferences, design preference, structural requirements, marketing preferences, cost, available materials, technological advances, etc., other vehicles such as, for example, cars, buses, SUVs 145, boats, planes, recreational vehicles, trailers, etc., may be sufficient.

Referring now to FIG. 2, showing a perspective view illustrating protective screen system 100 installed in window(s) 104 of vehicle 140 or sedan 200 according to an embodiment of the present invention.

As shown, protective screen system 100 is preferably installed in window 104, and optionally rear window 134 to protect passenger(s) 210, such as child 214, and/or pet 220. Protective screen system 100 preferably protects passenger 210 and/or pet 220 by decreasing the likelihood of ejection of passenger 210 and/or pet(s) 220 if vehicle 140 is involved in an accident. Using protective screen system 100 in rear window 134, as shown creates a barrier between the outer environment and the interior of vehicle 140 yet allowing sufficient ventilation to occur. Further, when protective screen system 100 is in an in-use condition 150, debris, bugs or other unwanted objects or particles are thereby prevented from entering vehicle 140 from outside. Further, protective screen system 100 substantially prevents children from throwing objects out window(s) 104 and/or sticking their limbs outside of vehicle 140, possibly preventing bodily harm. In this way the present invention serves to protect passengers from harm and increase their relative comfort levels while vehicle 140 is stationary or in transport. The present figure illustrates how the present invention may be used with side window(s) 130, rear window(s) 134 and other window 104 locations within vehicle 140.

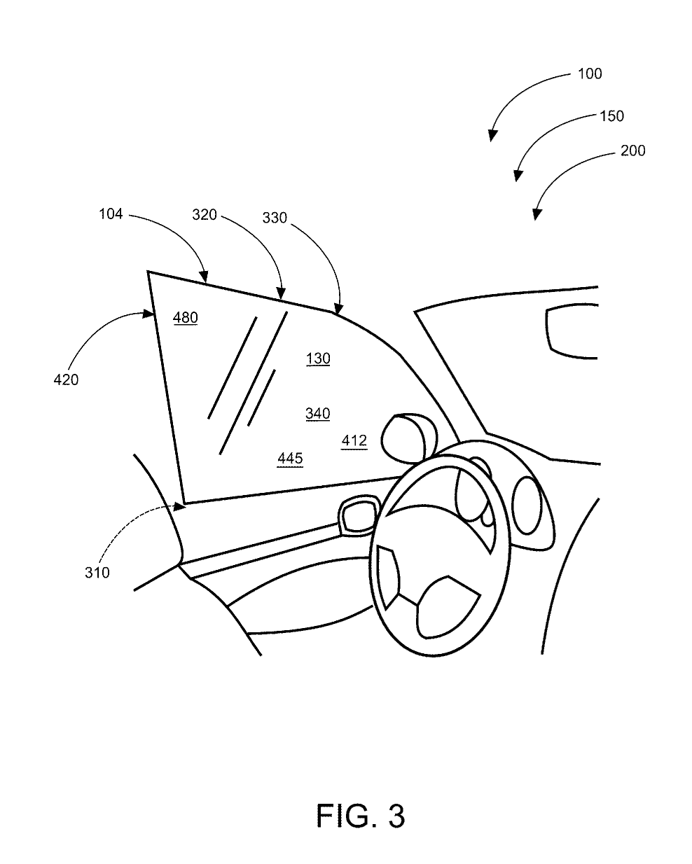

Referring now to FIG. 3, showing non-adjustable version 445 of protective screen system 100 in an ‘in-use’ condition 150 in vehicle 140 according to an embodiment of the present invention.

FIG. 3 shows protective screen 410 and screen frame 420 whereby protective screen system 100 is installable and preferably occupies the entire space of vehicle window opening 340. In this particular embodiment, protective screen 410 is non-size adjustable 445 and comprises screen frame locking unit 430 having periphery 320. Protective screen frame 420 may be inserted into vehicle window opening 340. When in ‘in-use’ condition 150, protective screen 410 and screen frame locking unit 430 are removably couplable to groove-space 310 of vehicle window frame 330. Groove-space 310 may comprise the gap located adjacent the edge of vehicle window frame 330 nearest the exterior of vehicle 140. In other embodiments not shown, groove-space 310 may be inserted adjacent the edge of vehicle window frame 330 nearest the interior. In this way the present invention may be installed on the inside or outside relative to vehicle window 104. Vehicle window 104 is not inhibited from up and down movement while adjustable version 440 of protective screen system 100 is in use or non-use. In certain embodiments of non-adjustable version 445 movement may be inhibited. Protective screen 410 and screen frame locking unit 430 may be installed or removed from vehicle window 104 at user discretion.

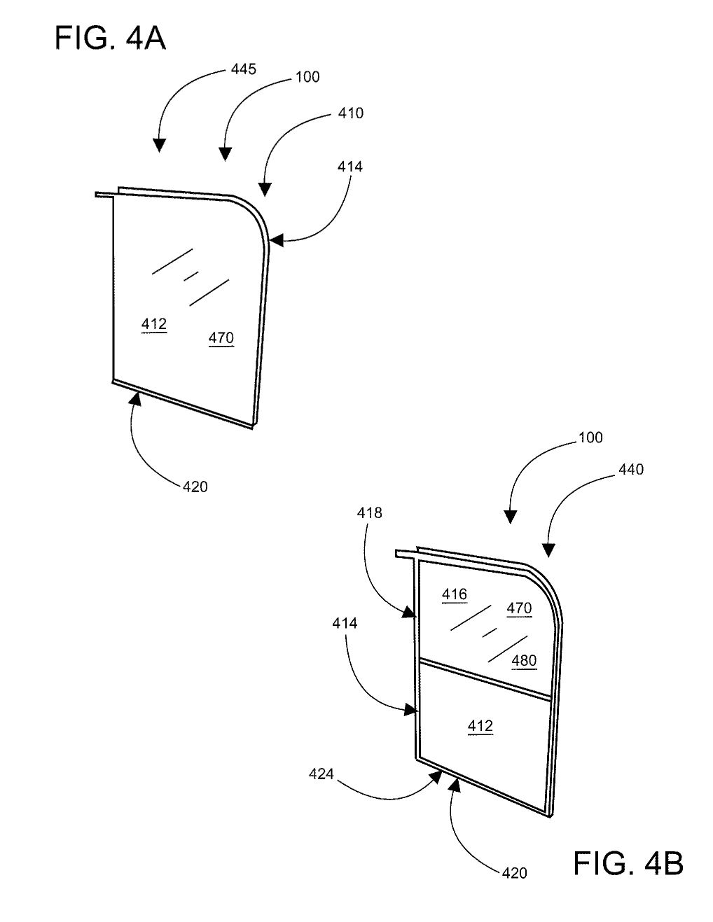

Referring now to FIGS. 4A and 4B, showing perspective views of the first and second embodiments of protective screen system 100. FIG. 4A is a perspective view illustrating a first variation of protective screen system 100 that is non-adjustable (non-adjustable version 445) according to an embodiment of the present invention.

Referring now to non-adjustable version 445 as shown in FIG. 4A, wherein protective screen 410 is shaped to fit an entire area of vehicle window opening 340 and is non-adjustable 445 as also previously mentioned in FIGS. 1-3. In the instant embodiment, protective screen system 100 may be retrofitted to fit the window of a truck 120, as shown in FIG. 1, SUV 145, as shown in FIG. 2, or other vehicle 140 window 104, as shown in FIG. 3. The protective screen system 100 may be sold in two or more variations as described herein.

Referring to FIG. 4B, showing a perspective view illustrating a second variation (herein embodying adjustable version 440) of protective screen 410 having adjustable first and second protective screens 412, 416, respectively, according to another embodiment of the present invention.

Adjustable version 440 comprises a plurality of protective screen(s) 410 as shown. It should be appreciated that more protective screen(s) 410 may be used within other embodiments (not shown) as needed. For example it may be desirable to use three or four or more protective screen(s) 410 to achieve the desired purpose. In this particular embodiment, first protective screen 412 of protective screen system 100 comprises first outer perimeter 414. Second protective screen 416 of protective screen system 100 comprises second outer perimeter 418. First protective screen 412 and second protective screen 416 are preferably movably adjustable in relation to each other via a sliding motion and form protective screen system assembly 402. First protective screen 412 may be lowered in relation to second protective screen 416 thereby creating a user-preferred open space 480 within vehicle window opening 340. It should be appreciated that the dimensions of open space 480 are adjustably limited due to second outer perimeter 418 of second protective screen 416. The amount of relative movement is limited because second protective screen 416 is stationary-mounted to vehicle window opening 340.

The present invention may be manufactured and sold as a kit comprising the components mentioned herein. The kit may comprise adjustable version 440 and/or non-adjustable version 445. The kit may include components to fit into vehicle window 104 of various locations (for example in side, rear, front, back-seat, vent, and others).

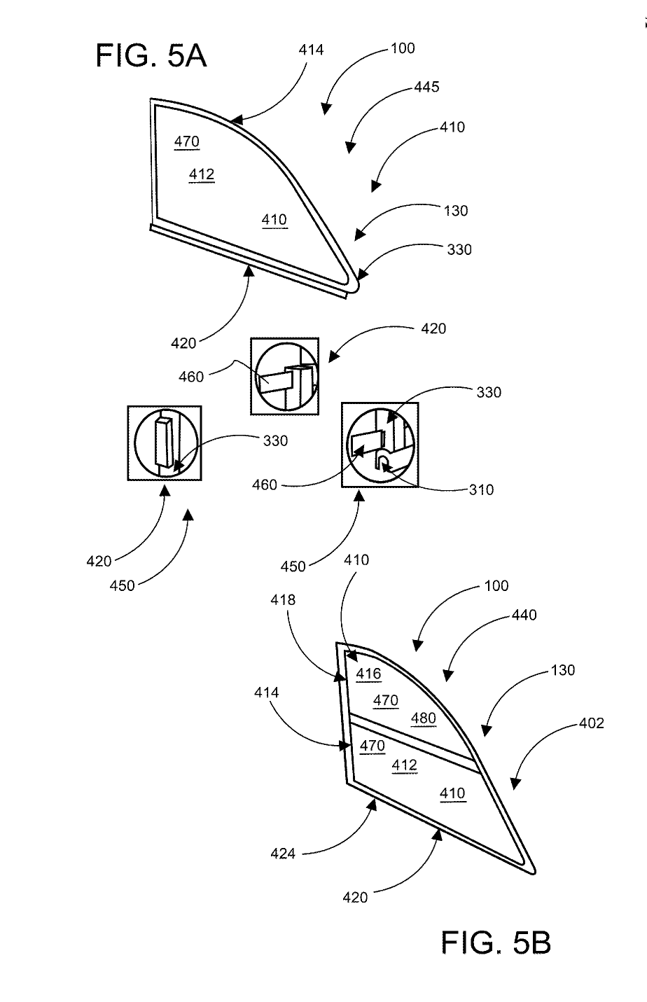

Screen frame locking unit 430 may be positioned along periphery 320 of protective screen(s) 410 in place, as also alluded to in FIG. 5. Protective screen system assembly 402 may be customized to the specifications of different types of vehicles 140, some of those described herein. Protective screen system assembly 402 herein comprising a movably couplable grooved locking unit 450 and bracket(s) 460 that may be inserted and suitably secured onto/into vehicle window opening 340. Using protective screen systems assembly 402 of the present invention does not block the travel of vehicle window 104 from manual or automatic height-adjustment by users.

FIG. 5A is a perspective view illustrating bracket(s) 460 as used on non-adjustable version 445 of protective screen 410 according to an embodiment of the present invention of FIG. 3.

FIG. 5B illustrates a perspective view including bracket(s) 460 as used on the first and second protective screens 412, 416, respectively, of adjustable version 440 of protective screen system 100 according to an embodiment of the present invention.

Referring now to FIGS. 5A and 5B, showing a perspective view of the protective screen frame 420 and screen frame locking unit 430, and more specifically to bracket(s) 460. In certain embodiments at least two bracket(s) 460 may be located on periphery 320 of screen frame locking unit 430.

Protective screen frame 420 may be inserted into vehicle window opening 340 whereby bottom 424 of screen frame 420 may comprise grooved locking unit 450 that may be securely latched onto the glass of the retracted vehicle window 130.

Protective screen system 100 may be manufactured to fit vehicle window 104 of a truck 120, as shown in FIGS. 1 and 4. Non-adjustable version 445 and adjustable versions 440 of the present invention may be used in sedan 200 or other vehicle(s) 140 as described above and shown in FIGS. 2 and 3.

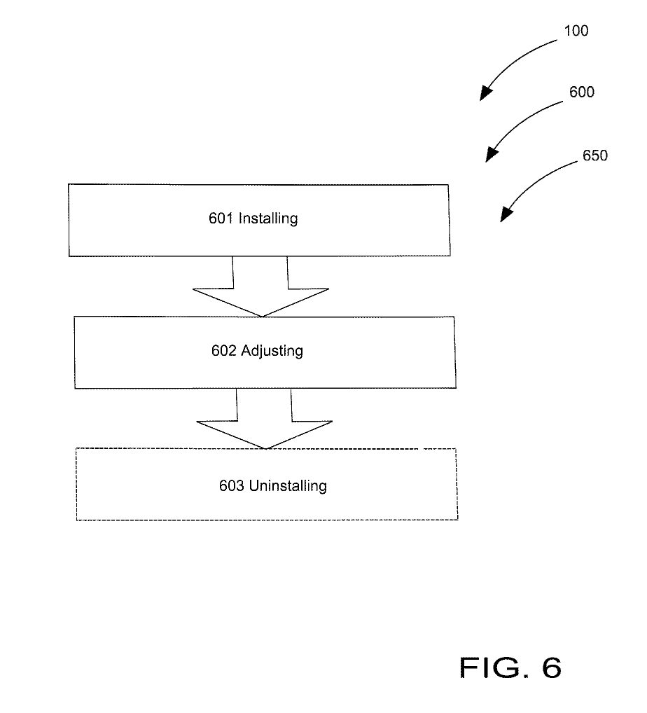

Referring now to FIG. 6, showing a flowchart 650 illustrating a method of use 600 according to an embodiment of the present invention of FIGS. 1-5B.

In accordance with the embodiments of the present invention a preferred method of use 600 is disclosed herein comprising: step one 601 installing protective screen system 100 with first protective screen 412 and second protective screen 416 into groove-space 310 of vehicle window frame 330; and step two 602 adjusting first and second protective screens 412 and 416, respectively, in relation to each other via a sliding motion to create a user-preferred open space 480. The method of use 600 may also include use with non-adjustable version 445. Further, protective screen system 100 may be installed and/or uninstalled from various vehicle windows 104, as described above in optional step 603.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A protective screen system for use with a vehicle comprising:
at least one protective screen; and
at least one lockable screen frame unit having a periphery;
wherein said protective screen and said lockable screen frame unit are removably couplable to a vehicle window.

2. The protective screen system of claim 1 wherein said protective screen serves to prevent debris, bugs or other unwanted objects or particles from entering the vehicle.

3. The protective screen system of claim 1 wherein said protective screen comprises a ventilating means.

4. The protective screen system of claim 1 wherein said protective screen further comprises at least one bracket located on said periphery of said lockable screen frame unit.

5. The protective screen system of claim 1, wherein said protective screen and lockable screen frame unit is removably couplable in a groove-space of a vehicle window.

6. The protective screen system of claim 5, wherein said protective screen system is installable in at least one side-window of said vehicle.

7. The protective screen system of claim 5, wherein said protective screen system is installable in at least one rear-window of said vehicle.

8. The protective screen system of claim 5, wherein the measurements of the protective screen system are manufactured to be installable into trucks.

9. The protective screen system of claim 5, wherein the measurements of the protective screen system are manufactured to be installable into cars.

10. The protective screen system of claim 5, wherein the measurements of the protective screen system are manufactured to be installable into SUVs.

11. The protective screen system of claim 5, wherein the measurements of the protective screen system are manufactured to be installable into buses.

12. The protective screen system of claim 5, wherein the measurements of the protective screen system are manufactured to be installable into recreational vehicles.

13. The protective screen system of claim 5, wherein the measurements of the protective screen system are manufactured to be installable into said vehicles including trucks, cars, SUVs, buses, and recreational vehicles.

14. The protective screen system of claim 5, wherein said protective screen system comprises a first protective screen with a first outer perimeter and a second protective screen with a second outer perimeter.

15. The protective screen system of claim 5, wherein said first and second protective screens are movably adjustable in relation to each other via a sliding motion.

16. The protective screen system of claim 15, wherein said first protective screen may be lowered in relation to said second protective screen thereby creating a user preferred open space.

17. The protective screen system of claim 16, wherein said open space is adjustably limited by said second perimeter of said second protective screen.

18. The protective screen system of claim 5, wherein said protective screen system is shaped to fit an entire area of said vehicle window and is non-adjustable.

19. A protective screen system for use with a vehicle comprising:
at least one protective screen serving to prevent particles from entering the vehicle having a ventilating means via a first protective screen with a first outer perimeter and a second protective screen with a second outer perimeter which are movably adjustable in relation to each other via a sliding motion and said first protective screen may be lowered in relation to said second protective screen thereby creating a user preferred open space adjustably limited by said second perimeter of said second protective screen;
at least one lockable screen frame unit having at least one periphery;
at least two brackets located on said periphery of said lockable screen frame unit;
wherein said protective screen and lockable screen frame unit are removably couplable in a groove-space of a vehicle window and is installable in at least one side-window and/or rear-window of said vehicle; and
wherein said protective screen system are manufactured to be installable into trucks, cars, SUVs, buses and recreational vehicles.

20. A method of using a protective screen system in a vehicle comprising the steps of:
installing said protective screen system with a first protective screen and a second protective screen into a groove-space of a vehicle window frame
adjusting said first and second protective screens in relation to each other via a sliding motion to create a user preferred open space.
